(19) United States
(12) Patent Application Publication
(10) Pub. No.: US 2009/0254603 A1
(43) Pub. Date: Oct. 8, 2009

(54) ACCESS SERVER FOR CERTIFYING AND VALIDATING DATA IN A PROCESSING NETWORK

(76) Inventor: Alistair Duncan, Danville, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/062,466

(22) Filed: Apr. 3, 2008

(51) Int. Cl. G06F 15/16

(52) U.S. Cl. 709/203

(57) ABSTRACT

An access server at individual issuer sites in a processing network facilitates communication with a processor. The processing network is a closed network under the control of the processor. The access server receives data from data providing entities for data certification and validation before the data is forwarded to the processor via the processing network. If the data cannot be certified because it is not properly formatted for the processor, the access server accesses the data in a format that can be processed by the processor. The extended access server also reports any errors to the issuer so that the issuer may address the errors and re-submit the data. After all errors are addressed, the properly formatted and error-free data is forwarded to the payment processor for processing.

### BACKGROUND

A payment processing network is commonly used to transmit financial transaction data between issuers, such as banks, and a payment processor, such as a credit institution. The payment processing network provides a communication path between the issuers and the payment processor. The payment processing network is usually a closed network to ensure secure transmission of the financial transaction data. Other data may also be transmitted between issuers and a payment processor via a network other than the payment processing network. The network used for transmitting the non-financial transaction data may be an open network such as the Internet. To enhance security, data transferred between the payment processor and the issuers over the Internet is commonly stored at an external site. In many cases, the data is transmitted in an encrypted form to prevent unauthorized access to the data at the external site.

When data is transmitted from an issuer to the payment processor over the Internet, the data is converted into a compatible format for transmission and processing at the payment processor. The data is encrypted and then sent via the Internet to the external site identified by a uniform resource locator (URL). The payment processor can access the external site but does not exert full control over data delivery.

The payment processor periodically scans the external site to access the data transmitted from different issuers. The periodic scan is necessary because the payment processor is not notified when the issuers send the data to the external site. Similarly, the payment processor is not notified when the issuers collect files stored on the external site by the payment processor. If data associated with a particular issuer is not stored at the external site, the payment processor may inform the issuer that the data has not been received and that the data should be sent. In some cases, the issuer may have submitted more than one version of the data to the external site since the last time the payment processor scanned the site.

The payment processor retrieves the most recent version of the data from the external site. The payment processor certifies the data to ensure that the data was sent in a format that can be processed by the payment processor because different issuers may send the financial transaction data in different formats. If the data was not sent in a proper format, the payment processor deviates from standard processing procedures to address the improper format. For example, the payment processor may convert the unformatted data into an acceptable format. Alternatively, the payment processor may inform the issuer that the data was not properly formatted and that the data should be resubmitted in the correct format. In some cases, the required format may include a non-standard encryption that many issuers are not equipped to process. Thus, the payment processor implements a compatible encryption system at the issuer sites.

After the data is properly formatted, the payment processor validates the data to check for any errors before fully processing the data. If the data includes any errors, the payment processor informs the corresponding issuer such that the issuer can correct the errors and resubmit the data. The validation process may include receiving test files from the issuer for processing the data and then compiling results of the executed test files to the issuer.

The conventional network for transmitting data between issuers and the payment processor requires the payment processor to actively participate in the data certification and validation process. Periodic scanning of the external site, informing the issuer of improper formatting or errors, waiting for the issuer to re-submit properly formatted and/or corrected data, installing a compatible encryption system at the issuer, etc., all create delays in data processing and increase operational and support costs for the payment processor.

Better ways to certify and validate data received from an issuer are desirable. Embodiments of the invention address the above problems, and other problems, individually and collectively.

### SUMMARY

Embodiments of the invention are directed to an access server installed at each issuer site in a processing network to facilitate communication with a processor. An issuer sends data previously received from a data providing entity to the access server for data certification and validation before the data is forwarded to the processor via the processing network. If the data is not certified, the issuer may convert the data into a format that can be processed by the processor. After the data is certified, the access server attempts to validate the data by checking for errors in the submitted data. If errors are found in the data, the access server may report the errors so that the issuer may address the errors and re-submit the data for validation. After all errors are addressed, the properly formatted and error-free data is forwarded to the processor for processing.

One embodiment of the invention is directed to a method for certifying and validating data for transmission across a processing network. The method includes receiving data from a data providing entity in a first format. The data is received at an access server associated with an issuer. The issuer comprises the access server. A determination is made whether the first format can be processed by a processor coupled to the processing network. In the event that the first format cannot be processed by the processor, the received data is accessed in a second format that can be processed by the processor. The data is validated and then forwarded to the processor via the processing network.

Another embodiment of the invention is directed to a secure processing network including an issuer and a processor. The issuer includes an access server. The access server includes a data receiving module, a data certification module and a data validation module. The data receiving module receives data in a first format from a data providing entity. The data certification module certifies the received data by determining whether a processor coupled to the processing network can process data in the first format. In the event that the first format is not a format that can be processed by the processor, the data certification module accesses the received data in a second format that can be processed by the processor. The data validation module validates the data to identify and address any errors. The processor then processes the validated data received from the issuer.

Another embodiment of the invention is directed to a method for certifying a data format for transmission across a processing network. The method includes receiving data in a first format from a data providing entity at an access server associated with an issuer. A determination is made whether the first format can be processed by a processor coupled to the processing network. In the event that the first format cannot be processed by the processor, the received data is accessed in a second format that can be processed by the processor.

Another embodiment of the invention is directed to a method for validating data for transmission across a processing network. The method includes receiving data at an issuer from a data providing entity. The data is received at an access server associated with the issuer. The data is then validated and forwarded to the processor via the processing network.

Other embodiments of the invention are directed to systems, servers, and computer readable media associated with the above-described methods.

These and other embodiments of the invention are described in further detail below with reference to the Figures and the Detailed Description.

### BRIEF DESCRIPTION OF THE DRAWINGS

FIG. 1 shows a block diagram of a system according to an embodiment of the invention.

FIG. 2 shows a flowchart illustrating a method according to an embodiment of the invention.

FIG. 3 shows another flowchart illustrating another method according to an embodiment of the invention.

FIG. 4 shows a block diagram of a computer apparatus that may be arranged to implement embodiments of the invention.

### DETAILED DESCRIPTION

An access server is installed at individual issuer sites in a processing network to facilitate communication with a processor. The processing network is a closed network under the control of the processor. In a closed network, many common security issues can be easily addressed to prevent unauthorized access without encrypting data. Certification and validation processes are shifted from the processor to the access servers at the issuer sites.

The issuer receives data from data providing entities, reformats the data and sends the reformatted data to the corresponding access server for data certification and validation before the data is forwarded to the processor via the processing network. The access server operates in a test mode to certify the format of the data. If the data format is not certified, the issuer may convert the data into a format that may be processed by the processor. After the data format is certified, the access server operates in an operational mode to validate the data by identifying any errors. If errors are found in the data, the access server may report the errors to the issuer so that the issuer may address the errors and re-send the data. After all errors are addressed, the access server forwards the properly formatted and error-free data to the processor for processing.

I. Systems

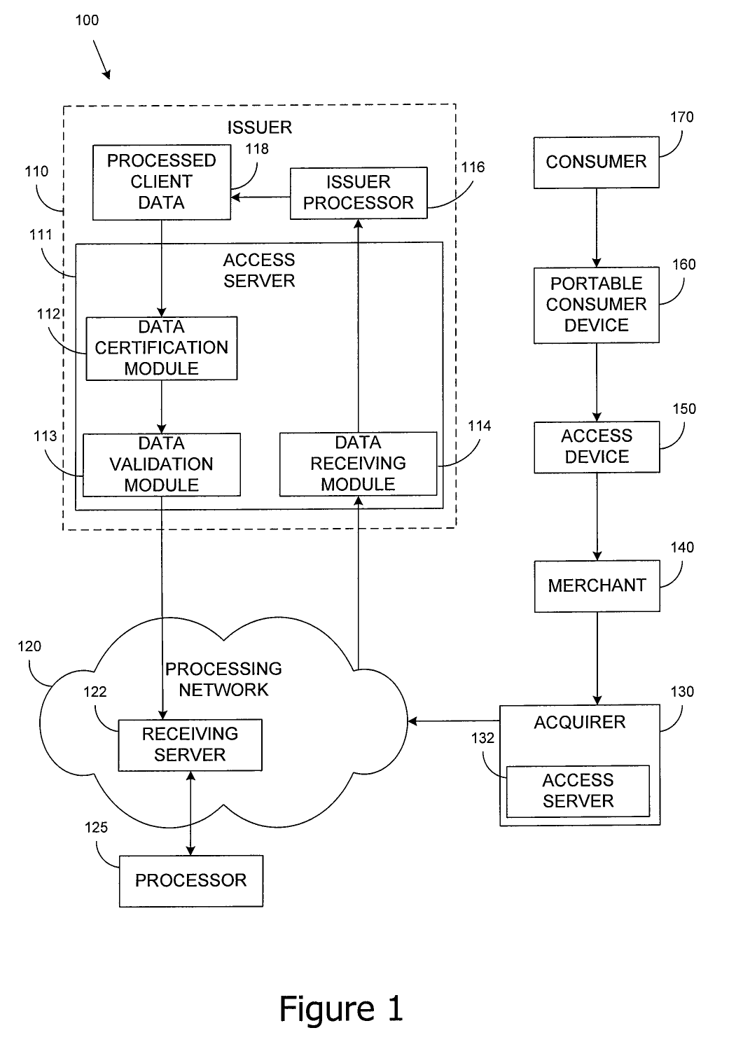

FIG. 1 shows an exemplary system 100 according to an embodiment of the invention. Other systems according to other embodiments of the invention may include more or less components than are shown in FIG. 1.

The system 100 shown in FIG. 1 includes a merchant 140 and an acquirer 130 associated with the merchant 140. In a typical payment transaction, a consumer 170 may purchase goods or services at the merchant 140 using a portable consumer device 160. The acquirer 130 can communicate with an issuer 110 via a processing network 120.

The consumer 170 may be an individual, or an organization such as a business that is capable of purchasing goods or services. In other embodiments, the consumer 170 may simply be a person who wants to conduct some other type of transaction such as a money transfer transaction. The consumer 170 may optionally operate an access device 150 such as a wireless phone.

The merchant 140 may also have, or may receive communications from, the access device 150 that can interact with the portable consumer device 160. The access device 150 can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device 150 is a point of sale terminal, any suitable point of sale terminal may be used including card readers. The card readers may include any suitable contact or contactless mode of operation. For example, exemplary card readers can include RF (radio frequency) antennas, magnetic stripe readers, etc. to interact with the portable consumer devices 160.

The portable consumer device 160 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones (e.g., the access device 150 described above), personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

The processing network 120 may include data processing subsystems, networks, and operations used to support and deliver authorization services, exception file services, and clearing and settlement services. An exemplary processing network may include VisaNet™. Processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. VisaNet™ is a secure, closed network that links the issuer 110 to the acquirer 130 and to a processor 125. The processing network (e.g. VisaNet™) performs two main processes: 1) approve credit card transactions; and 2) settle each issuer's transactions at the end of the day.

The processor 125 is associated with a receiving server 122 that is part of the processing network 120. The receiving server 122 is typically a powerful computer or cluster of computers. For example, the receiving server 122 can be a large mainframe, a minicomputer cluster, or a group of servers functioning as a unit. In one example, the receiving server 122 may be a database server coupled to a Web server.

The issuer 110 may be a bank or other organization that may have an account associated with the consumer 170. The issuer 110 receives client data at a data receiving module 114 from any one of the following data providing entities: the acquirer 130, the merchant 140, the access device 150, the portable consumer device 160 or the consumer 170. The data receiving module 114 forwards the received data to an issuer processor 116 which processes the client data to form processed client data 118. The issuer 110 operates an access server 111. The access server 111 includes the data receiving module 114, a data certification module 112 and a data validation module 113. The data certification module 112 is configured to certify that the processed client data 118 is properly formatted before the data is validated. The data validation module 113 is configured to validate the processed client data 118 by checking the data for errors before the data is sent to the processor 125 via the processing network 120. In some embodiments, an access server 132 is also provided at the acquirer 130.

In one embodiment, the data to be sent by the issuer 110 to the processor 125 includes commercial financial transactions performed by corporate clients. Data files are sent by the issuer 110 on a daily basis. Each file may include a transaction made by a client using a corporate credit card. The data files may include all of the transactions made by all of the corporate cards since the last processing period. The data files may also include registration details of any new cards that have been issued since the last processing period. Other information in the data files compiled by the issuer 110 may include details related to corporate hierarchy (individual or departmental) and transaction types. The issuer 110 compiles all of the data taking into account different transaction types and formats, and ensuring that the data is input correctly.

The access server 111 operates in a test mode when receiving data from an entity that has not previously provided data to the access server 112. The access server 111 may also operate in a test mode when the internal configuration of the issuer 110 has been modified. The purpose of the test mode is to identify whether data received or stored at the issuer 110 is properly formatted for processing by the processor 125. Thus, the access server 111 need not operate in the test mode if the data is received from an entity that has previously provided data in a correct format and if the issuer 110 has not been reconfigured since a previous certification process was performed.

The data certification module 112 ensures that the data is in a format that can be processed by the processor 125. In one embodiment, the data certification module 112 converts the data to be sent by the issuer 110 to a proper format using a mapping tool. The mapping tool maps one field in the data to be sent to a corresponding field in the proper format for processing by the processor 125. For example, a field for transaction posting date is included in the issuer-formatted data and the processor-formatted data. The mapping tool maps together the two fields for the transaction posting date. The mapping is performed for all other fields in each data record to be sent by the issuer 110 until all of the data elements are converted into a format that can be processed by the processor 125.

After the data is properly formatted, the access server 111 operates in an operational mode to identify errors in the data. The data validation module 113 ensures that the data does not include any errors. The data validation module 113 executes a series of validation checks to ensure that the data is correct and complete. Many types of errors may exist. For example, a required field may be empty. A field may include invalid data (e.g., numeric data rather than alphabetic data, an invalid country/currency code, an incomplete account number, etc.). Other errors may be related to the order in which the data is to be sent from the issuer 110 to the processor 125. For example, the issuer 110 may attempt to send data related to transactions for a particular credit card before registration information for that credit card is sent to the processor 125. The data validation module 113 may also reject duplicate files by allowing only the most current file to be forwarded to the processor 125. Additional errors may be checked by the data validation module 113 such that the data files contain no errors before being forwarded to the processor 125 for processing.

If the data validation module 113 identifies any errors in the data, the issuer 110 is notified that data correction is necessary. In one embodiment, the data validation module 113 compiles the errors in an error report. The error report may identify the data record that includes the error and a description of the error. The error report is submitted to the issuer 110 so that the issuer 110 is notified about how to correct the error. The errors may then be addressed and the data re-submitted to the data validation module 113 to check if the errors have been corrected. After the data validation module 113 determines that the data is error-free, the data is forwarded to the processor 125 via the processing network 120. Thus, the data received by the processor 125 from the issuer 110 is properly formatted and error-free. In one embodiment, the data is stored at the receiving server 122 before being transmitted to the processor 125.

Embodiments of the invention are not limited to the above-described embodiments. For example, although separate functional blocks are shown for the issuer, the processing network, and the processor, some entities perform all or any suitable combination of these functions and may be included in embodiments of invention. For simplicity of illustration, one issuer, one consumer, one portable consumer device, one access device, one merchant, one acquirer, one processor, and one receiving server are shown. It is understood, however, that embodiments of the invention may include multiple issuers, consumers, portable consumer devices, acquirers, access devices, etc. In addition, some embodiments of FIG. 1 may include fewer than all of the components shown in FIG. 1. Additional components may also be included in embodiments of the invention. Also, the components of FIG. 1 may communicate via any suitable communication medium (including the Internet), using any suitable communication protocol.

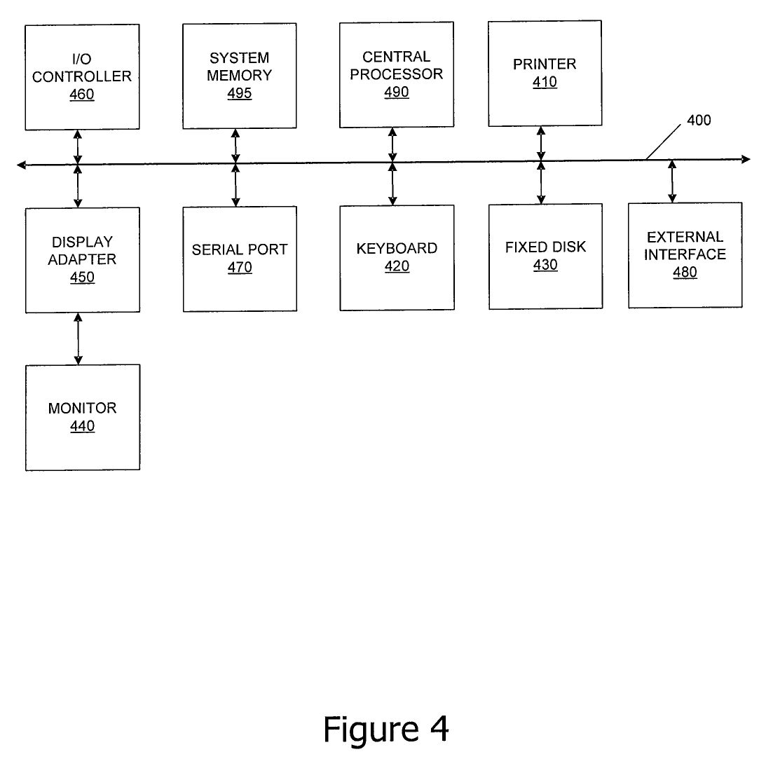

FIG. 4 shows typical components or subsystems of a computer apparatus. Such components or any subset of such components may be present in various components shown in FIG. 1, including the access device 150, extended access server 111, receiving server 122, etc. The subsystems shown in FIG. 4 are interconnected via a system bus 400. Additional subsystems such as a printer 410, keyboard 420, fixed disk 430, monitor 440, which is coupled to display adapter 450, and others are shown. Peripherals and input/output (I/O) devices, which couple to I/O controller 460, can be connected to the computer system by any number of means known in the art, such as serial port 470. For example, serial port 470 or external interface 480 can be used to connect the computer apparatus to a wide area network such as the Internet, a mouse input device, or a scanner. The interconnection via system bus 400 allows the central processor 490 to communicate with each subsystem and to control the execution of instructions from system memory 495 or the fixed disk 430, as well as the exchange of information between subsystems. The system memory 495 and/or the fixed disk 430 may embody a computer readable medium.

II. Methods

Methods according to embodiments of the invention can be described with reference to FIGS. 1, 2 and 3. In a typical purchase transaction, the consumer 170 purchases a good or service at the merchant 140 using a portable consumer device 160 such as a credit card. The consumer's portable consumer device 160 can interact with an access device 150 such as a POS (point of sale) terminal at the merchant 140. For example, the consumer 170 may swipe a credit card through an appropriate slot in the POS terminal. Alternatively, the POS terminal may be a contactless reader, and the portable consumer device 160 may be a contactless device such as a contactless card.

Over the course of a transaction reporting period (e.g., twenty-four hours) several different transactions are performed by multiple consumers 170 using portable consumer devices 160 associated with different issuers 110. At the end of the reporting period, a normal clearing and settlement process can be conducted by over the processing network 120. A clearing process is a process of exchanging financial details between the acquirer 130 and the issuer 110 to facilitate posting to a consumer's account and reconciliation of the consumer's settlement position. Clearing and settlement can occur simultaneously.

An access server 111 is installed at each issuer site coupled to the processing network 120 to facilitate communication with the processor 125. The processing network 120 is a closed network under the control of the processor 125. In a closed network, many common security issues can be easily addressed to prevent unauthorized access without encrypting data.

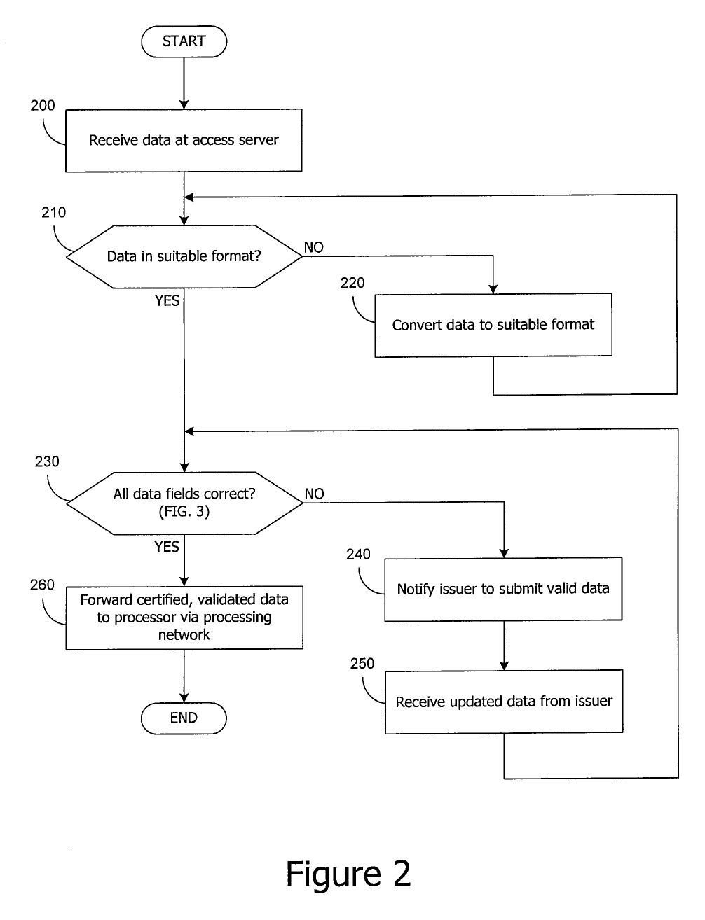

The processing in the access server 111 is described with reference to FIG. 2. The access server 111 receives data previously sent by a data providing entity associated with the issuer 110 such as the acquirer 130, the merchant 140, the access device 150, the portable consumer device 160 or the consumer 170. The access server 111 certifies and validates the received data before the data is forwarded to the processor 125 via the processing network 120 (step 200).

The access server 111 operates in a test mode to certify the data. In some embodiments, the access server 111 operates in a test mode when receiving data from an entity that has not previously provided data to the access server 111. The access server 111 may also operate in a test mode when the internal configuration of the issuer 110 has been modified. The purpose of the test mode is to identify whether data received or stored at the issuer 110 is properly formatted for processing by the processor 125.

The data certification module 112 determines whether the data is in a format that can be processed by the processor 125 (step 210). If the data is in a format that can be processed by the processor 125, processing continues to step 230. If the data is in a format that cannot be processed by the processor 125, processing continues to step 220.

If the data is not properly formatted for processing by the processor 125, the issuer 110 may convert the data to a format that can be processed by the processor 125 (step 220). In one embodiment, the data certification module 112 converts the data into the proper format using a mapping tool. The mapping tool maps one field in the data to be sent to a corresponding field in the proper format for processing by the processor 125. The mapping is performed for all fields in each data record to be sent by the issuer 110 until all of the data elements are converted into a format that can be processed by the processor 125.

After the data is converted by the issuer 110, processing may return to step 210 where the data certification module 112 determines whether the data is in a format that can be processed by the processor 125. In some embodiments, the re-certification of the data is not necessary because the issuer 110 converted the data into a format that is known to be processed by the processor 125. In some embodiments, data subsequently received from the data providing entity that previously provided properly formatted data to the issuer 110 need not be certified since the data will be properly formatted for the processor 125.

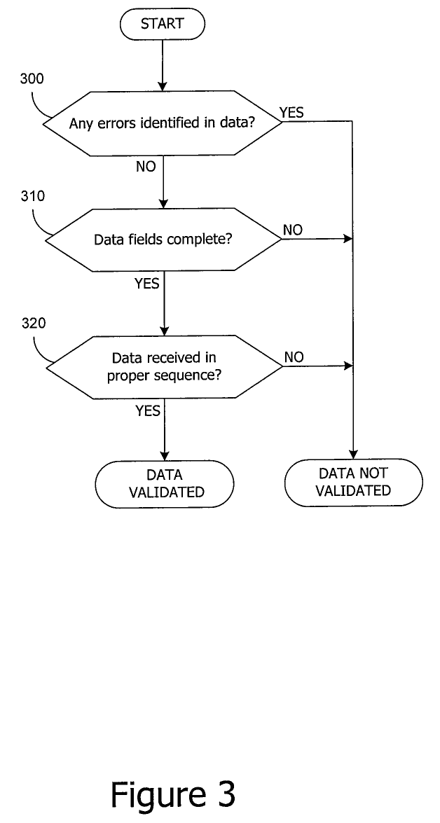

After the data is certified, the access server 111 operates in an operational (i.e., live) mode. The data validation module 113 validates the certified data to identify any errors (step 230). The processing of the data validation module 113 is described in detail with reference to FIG. 3. If the data validation module 113 determines that the data is valid, processing continues at step 260. If the data validation module 113 determines that the certified data contains errors, processing continues at step 240.

The data validation module 113 notifies the issuer 110 that data correction is necessary (step 240). In one embodiment, the data validation module 113 compiles the errors in an error report. The error report may identify the data record that includes the error and a description of the error. Thus, the issuer 110 is notified about how to correct the error. The issuer 110 may then attempt to correct the errors by updating the data.

The access server 111 receives the updated data from the issuer 110 (step 250). The access server 112 then submits the updated data to the data validation module 113 to determine whether the updated data is valid (step 230). The processing loop of identifying errors, updating the invalid data, and checking the updated data for errors is repeated until the data validation module 113 determines that the data is error-free.

The access server 111 then forwards the certified, validated data to the processor 125 via the processing network 120 (step 260). In one embodiment, the data is stored at the receiving server 122 before being transmitted to the processor 125. Thus, the data received by the processor 125 from the issuer 110 is properly formatted (i.e., certified) and error-free (i.e., validated) such that the processor 125 may initiate processing without certifying or validating the received data.

The processing steps of the data validation module 113 will be described with reference to FIG. 3. The data validation module 113 executes a series of validation checks to ensure that the data to be sent to the processor 125 is correct and complete. The data validation module 113 determines whether any errors are identified in the data by ensuring that the data is properly input into the corresponding field in the data record (step 300).

Many different types of errors may be identified in the data. For example, a data field for an account number may include alphabetic data rather than numeric data. The data validation module 113 also determines whether the data fields are complete (step 310). For example, a required field may be empty or may be missing information (e.g., no area code received with telephone number data).

The data validation module 113 may also determine whether data records are received in a proper sequence (step 320). For example, the issuer 110 may attempt to send data related to transactions for a particular credit card before registration information for that credit card is sent to the processor 125. The data validation module 113 may also reject duplicate files by allowing only the most current file to be forwarded to the processor 125. Additional errors may be checked by the data validation module 113 such that the data files contain no errors before being forwarded to the processor 125.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for certifying and validating data for transmission across a processing network, the method comprising:
receiving data in a first format from a data providing entity, wherein the data is received at an access server associated with an issuer, the issuer comprising the access server;
determining whether the first format can be processed by a processor coupled to the processing network;
in the event that the first format cannot be processed by the processor, accessing the received data in a second format, wherein the second format can be processed by the processor;
validating the data; and
forwarding the validated data to the processor via the processing network.

2. The method of claim 1 wherein validating the data comprises identifying any errors in the data.

3. The method of claim 2 further comprising:
in the event that an error is identified in the data,
requesting the issuer to correct the data.

4. The method of claim 2 further comprising:
in the event that an error is identified in the data,
sending a report to the issuer, wherein the report includes at least one error identified in the data.

5. The method of claim 1 wherein validating the data comprises identifying whether fields in the data are complete.

6. The method of claim 5 further comprising:
in the event that a field in the data is not identified as complete,
requesting the issuer to complete the data.

7. The method of claim 5 further comprising:
in the event that a field in the data is not identified as complete,
sending a report to the issuer, wherein the report includes fields not identified as complete in the data.

8. The method of claim 1 wherein validating the data comprises identifying whether the data is received in a proper sequence.

9. The method of claim 8 further comprising:
in the event that the data is not received in the proper sequence,
requesting the issuer to provide the data in the proper sequence.

10. The method of claim 8 further comprising:
in the event that the data is not received in the proper sequence,
sending a report to the issuer, wherein the report identifies the proper sequence by which the data is to be sent.

11. The method of claim 1 further comprising:
in the event that the first format cannot be processed by the processor,
converting the data to the second format.

12. The method of claim 11 wherein converting the data to the second format comprises mapping each field of data in the first format to a corresponding field in the second format.

13. The method of claim 1 further comprising:
in the event that the first format cannot be processed by the processor,
requesting the issuer to convert the data to the second format.

14. The method of claim 1 further comprising:
in the event that the first format cannot be processed by the processor,
sending a report to the issuer, wherein the report identifies the first format as a format that cannot be processed by the processor.

15. The method of claim 1 wherein the data is associated with credit card and commercial transaction information.

16. The method of claim 1 wherein the issuer is a financial institution.

17. The method of claim 1 further comprising preventing unauthorized access to the forwarded data without encrypting the data.

18. A secure processing network comprising:
a processor; and
an issuer comprising an access server, the access server comprising:
a data receiving module for receiving data in a first format from a data providing entity;
a data certification module for certifying the received data, wherein the data certification module accesses the received data in a second format when the first format cannot be processed by a processor coupled to the processing network, the second format being processed by the processor, and
a data validation module for validating the certified data, wherein the processor is configured to process the validated data received from the issuer.

19. The secure processing network of claim 18 wherein the data validation module is configured to identify any errors in the converted data.

20. The secure processing network of claim 18 wherein the data validation module is configured to identify whether fields in the certified data are complete.

21. The secure processing network of claim 18 wherein the data validation module is configured to identify whether the data is received at the data receiving module in a proper sequence.

22. The secure processing network of claim 18 wherein the data certification module is configured to determine whether the first format is a format that can be processed by the processor.

23. The secure processing network of claim 18 wherein the data certification module is configured to convert the data in the first format to the second format by mapping each field of data in the first format to a corresponding field in the second format.

24. The secure processing network of claim 18 wherein the data certification module is configured to request that the issuer converts the data to the second format.

25. A system for validating data in a processing network, the system comprising:
means for receiving data in a first format from a data providing entity, wherein the data is received at an access server associated with an issuer, the issuer comprising the access server;
means for accessing the received data in a format that can be processed by a processor, wherein the processor is coupled to the processing network;
means for validating the data; and
means for forwarding the validated data to the processor via the processing network.

26. A computer readable medium comprising:
code for receiving data in a first format from a data providing entity, wherein the data is received at an access server associated with an issuer, the issuer comprising the access server;
code for accessing the received data in a format that can be processed by a processor, wherein the processor is coupled to the processing network;
code for validating the data; and
code for forwarding the validated data to the processor via the processing network.

27. A server comprising the computer readable medium of claim 26.

28. A method for certifying a data format for transmission across a processing network, the method comprising:
receiving data in a first format from a data providing entity, wherein the data is received at an access server associated with an issuer, the issuer comprising the access server;
determining whether the first format can be processed by a processor coupled to the processing network; and
in the event that the first format cannot be processed by the processor, accessing the received data in a second format, wherein the second format can be processed by the processor.

29. The method of claim 28 further comprising:
in the event that the first format cannot be processed by the processor,
converting the data to the second format.

30. The method of claim 29 wherein converting the data to the second format comprises mapping each field of data in the first format to a corresponding field in the second format.

31. The method of claim 28 further comprising:
in the event that the first format cannot be processed by the processor,
requesting the issuer to convert the data to the second format.

32. The method of claim 28 further comprising:
in the event that the first format cannot be processed by the processor,
sending a report to the issuer, wherein the report identifies the first format as a format that cannot be processed by the processor.

33. A method for validating data for transmission across a processing network, the method comprising:
receiving data from a data providing entity, wherein the data is received at an access server associated with an issuer, the issuer comprising the access server;
validating the data; and
forwarding the validated data to the processor via the processing network.

34. The method of claim 33 wherein validating the data comprises identifying any errors in the data.

35. The method of claim 34 further comprising:
in the event that an error is identified in the data,
requesting the issuer to correct the data.

36. The method of claim 34 further comprising:
in the event that an error is identified in the data,
sending a report to the issuer, wherein the report includes at least one error identified in the data.

37. The method of claim 33 wherein validating the data comprises identifying whether fields in the data are complete.

38. The method of claim 37 further comprising:
in the event that a field in the data is not identified as complete,
requesting the issuer to complete the data.

39. The method of claim 37 further comprising:
in the event that a field in the data is not identified as complete,
sending a report to the issuer, wherein the report includes fields not identified as complete in the data.

40. The method of claim 33 wherein validating the data comprises identifying whether the data is received in a proper sequence.

41. The method of claim 40 further comprising:
in the event that the data is not received in the proper sequence,
requesting the issuer to provide the data in the proper sequence.

42. The method of claim 40 further comprising:
in the event that the data is not received in the proper sequence,
sending a report to the issuer, wherein the report identifies the proper sequence by which the data is to be sent.
